(19) United States
(12) Patent Application Publication
(10) Pub. No.: US 2017/0113457 A1
(43) Pub. Date: Apr. 27, 2017

(54) INKJET HEAD AND INKJET PRINTER

(71) Applicant: TOSHIBA TEC KABUSHIKI KAISHA, Tokyo (JP)

(72) Inventors: Isao Suzuki, Mishima Shizuoka (JP); Masaya Ichikawa, Kannami Tagata Shizuoka (JP); Noriyuki Kikuchi, Mishima Shizuoka (JP)

(21) Appl. No.: 15/242,793

(22) Filed: Aug. 22, 2016

(30) Foreign Application Priority Data
Oct. 27, 2015 (JP) 2015-210707
Jun. 3, 2016 (JP) 2016-111831

(51) Int. Cl. B41J 2/045

(52) U.S. Cl. CPC B41J 2/04541; B41J 2/04586; B41J 2/04596

(57) ABSTRACT

In accordance with an embodiment, an inkjet head comprises a plurality of first driving elements, a plurality of second driving elements, a common liquid chamber and a controller. A plurality of the first driving elements constitutes a plurality of first pressure chambers respectively communicating with a plurality of first integrated nozzles. A plurality of the second driving elements constitutes a plurality of second pressure chambers respectively communicating with a plurality of second integrated nozzles. The common liquid chamber communicates with a plurality of the first pressure chambers and a plurality of the second pressure chambers. The controller applies an ejection pulse to the first driving element and at least one non-ejection pulse to the second driving element before an end timing of the ejection pulse.

### CROSS-REFERENCE TO RELATED APPLICATIONS

The present application is based upon and claims the benefit of priorities from Japanese Patent Application No. P2015-210707 filed on Oct. 27, 2015 and Japanese Patent Application No. P2016-111831 filed on Jun. 3, 2016, the entire contents of which are hereby incorporated by reference.

### FIELD

Embodiments described herein relate generally to an inkjet head and an inkjet printer.

### BACKGROUND

An inkjet head of an inkjet printer is equipped with a plurality of ejection areas including a plurality of nozzles. A plurality of the ejection areas ejects ink onto a print medium such as a paper at different timing. For example, the inkjet head ejects ink from a second ejection area after ejecting the ink from a first ejection area. In some cases, conventional inkjet heads undesirably fail to eject the ink from a next ejection area due to an effect of nozzle negative pressure generated in the initial ejection area.

### DESCRIPTION OF THE DRAWINGS

FIG. 1 is a diagram illustrating an example of the configuration of an inkjet printer according to a first embodiment;

FIG. 2 a perspective view of an inkjet head according to the first embodiment;

FIG. 3 is a cross-sectional view of the inkjet head according to the first embodiment;

FIG. 4 is an exploded perspective view illustrating the exploded inkjet head according to the first embodiment;

FIG. 5 is a cross-sectional view of the inkjet head according to the first embodiment;

FIG. 6 is a plan view illustrating a nozzle plate from a first surface side according to the first embodiment;

FIG. 7 is a cross-sectional view of the nozzle plate according to the first embodiment;

FIG. 8 is a plan view illustrating the nozzle plate from a second surface side according to the first embodiment;

FIG. 9 is a cross-sectional view of the inkjet head along a thickness direction of the nozzle plate according to the first embodiment;

FIG. 10 is a diagram illustrating an example of operations of the inkjet head according to the first embodiment;

FIG. 11 is a diagram illustrating an example of the operations of the inkjet head according to the first embodiment;

FIG. 12 is a timing chart illustrating an example of a pulse applied to the inkjet head according to the first embodiment;

FIG. 13 is a timing chart illustrating another example of the pulse applied to the inkjet head according to the first embodiment;

FIG. 14 is a timing chart illustrating a concrete example of the pulse applied to the inkjet head according to the first embodiment;

FIG. 15 is a diagram illustrating a relation between a non-ejection pulse width and ejection failure according to the first embodiment;

FIG. 16 is a diagram illustrating another example of the inkjet printer according to the first embodiment;

FIG. 17 is a diagram illustrating a relation between an ejection voltage and a thickness of the nozzle plate of an inkjet printer according to a second embodiment; and

FIG. 18 is a diagram illustrating a relation between ejection failure and the configuration of a nozzle of the inkjet printer according to the second embodiment.

### DETAILED DESCRIPTION

In accordance with an embodiment, an inkjet head comprises a plurality of first driving elements, a plurality of second driving elements, a common liquid chamber and a controller. A plurality of the first driving elements contains a plurality of first pressure chambers respectively communicating with a plurality of first integrated nozzles containing at least two nozzles. A plurality of the second driving elements contains a plurality of second pressure chambers respectively communicating with a plurality of second integrated nozzles containing at least two nozzles. The common liquid chamber communicates with a plurality of the first pressure chambers and a plurality of the second pressure chambers. The controller applies an ejection pulse to the first driving element and at least one non-ejection pulse to the second driving element before an end timing of the ejection pulse.

In accordance with another embodiment, inkjet printing method involves applying an ejection pulse to a plurality of first driving elements comprising a plurality of first pressure chambers respectively communicating with a plurality of first integrated nozzles; and applying at least one non-ejection pulse to a plurality of second driving elements comprising a plurality of second pressure chambers respectively communicating with a plurality of second integrated nozzles before an end timing of the ejection pulse.

Hereinafter, the embodiment is described with reference to the accompanying drawings.

### First Embodiment

First, a first embodiment is described.

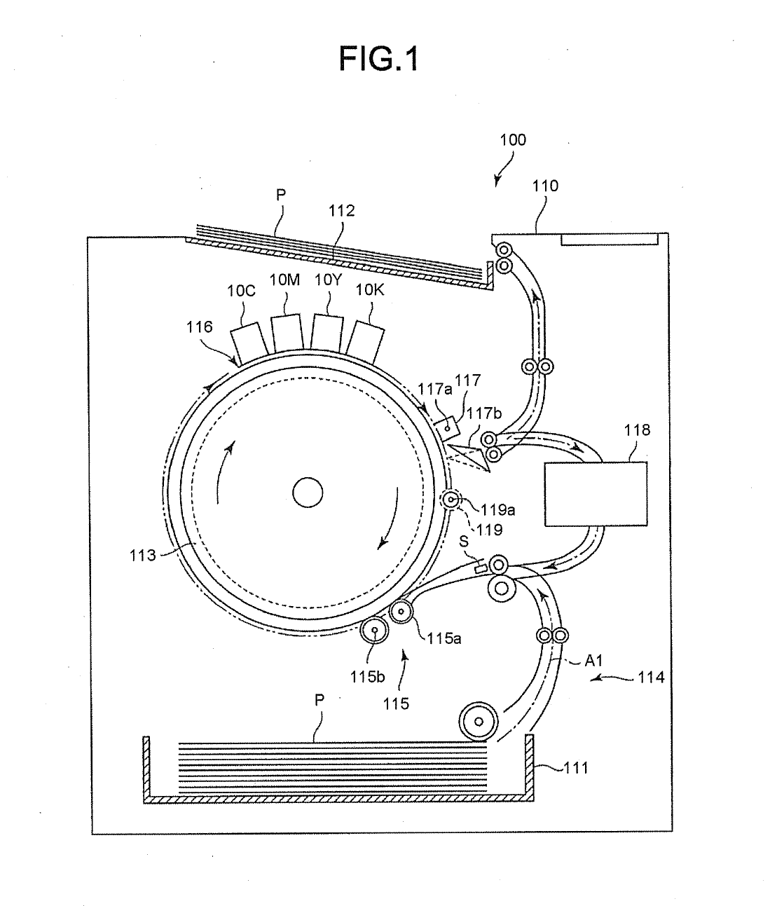

FIG. 1 is a diagram illustrating an example of the configuration of an inkjet printer 100 according to the first embodiment.

The inkjet printer 100 conveys a paper P as a print medium along a predetermined conveyance route while carrying out various processing such as an image forming processing and the like. The inkjet printer 100 is equipped with an inkjet head 10, a housing 110, a paper feed cassette 111 as a paper supply section, a paper discharge tray 112 as a discharge section, a holding roller 113, a conveyance device 114 and a reversing device 118.

The housing 110 constitutes the contour of the inkjet printer 100. The paper feed cassette 111 is arranged inside of the housing 110. The paper feed cassette 111 stores the paper P. The paper discharge tray 112 is arranged above the housing 110. The paper discharge tray 112 discharges the paper P on which an image is formed.

The holding roller 113 (drum) holds the paper P on the outer surface thereof to rotate. The conveyance device 114 conveys the paper P along a predetermined conveyance path A1 formed from the paper feed cassette 111 to the paper discharge tray 112 via the outer circumference of the holding roller 113. The reversing device 118 reverses front and rear surfaces of the paper P peeled from the holding roller 113 to supply the reversed paper P to the surface of the holding roller 113 again.

The conveyance device 114 is equipped with a plurality of guide members and a plurality of rollers for conveyance arranged along the conveyance path A1. The rollers for conveyance include a pickup roller, a paper feed roller pair, a resist roller pair, a separation roller pair, a conveyance roller pair and a discharge roller pair. These rollers for conveyance are driven by a motor for conveyance to rotate to send the paper P to the downstream side along the conveyance path A1.

Sensors S for monitoring conveyance states of the paper are arranged in various places of the conveyance path A1. The holding roller 113 rotates in a state of holding the paper P on the surface thereof to convey the paper P.

On the outer peripheral part of the holding roller 113, a holding device 115, a head unit 116, a discharge peeling device 117 and a cleaning device 119 are arranged in order from the upstream side to the downstream side.

The holding device 115 is equipped with a pressing roller 115a and a charging roller 115b. The pressing roller 115a presses the outer surface of the holding roller 113. The charging roller 115b generates (charges) electrostatic force of a direction in which the paper P is absorbed on the outer surface of the holding roller 113 through supplied electric power. The holding roller 113 absorbs the paper P through the electrostatic force.

The head unit 116 includes a plurality of (four colors) inkjet heads 10 oppositely arranged on the outer surface of the holding roller 113. For example, the head unit 116 is equipped with a cyan inkjet head 10C, a magenta inkjet head 10M, a yellow inkjet head 10Y and a black inkjet head 10K. The inkjet heads 10C, 10M, 10Y and 10K respectively eject ink from nozzle holes arranged at a predetermined pitch. The inkjet heads 10C, 10M, 10Y and 10K discharge the ink to form an image on the paper P held on the outer surface of the holding roller 113. The inkjet head 10 (100, 10M, 10Y and 10K) is described in detail later.

The discharge peeling device 117 is equipped with a discharge roller 117a for removing the electrostatic force of the paper P and a peeling claw 117b for peeling the paper P from the holding roller 113.

The cleaning device 119 is equipped with a cleaning member 119a that rotates in a state of contacting with the holding roller 113 to clean the holding roller 113.

The reversing device 118 reverses the paper P peeled from the holding roller 113 to supply the reversed paper P to the surface of the holding roller 113 again.

The inkjet printer 100 is further equipped with a controller, a ROM, a RAM and an I/F (interface). The controller (central control unit) is, for example, a processor such as a CPU. The ROM is a memory for storing various programs. The RAM is a memory for temporarily storing various variable data, image data and the like. The I/F (interface) inputs data from an external device or outputs data to the external device. Furthermore, the inkjet printer 100 may be further equipped with proper elements which are necessary or delete unnecessary elements.

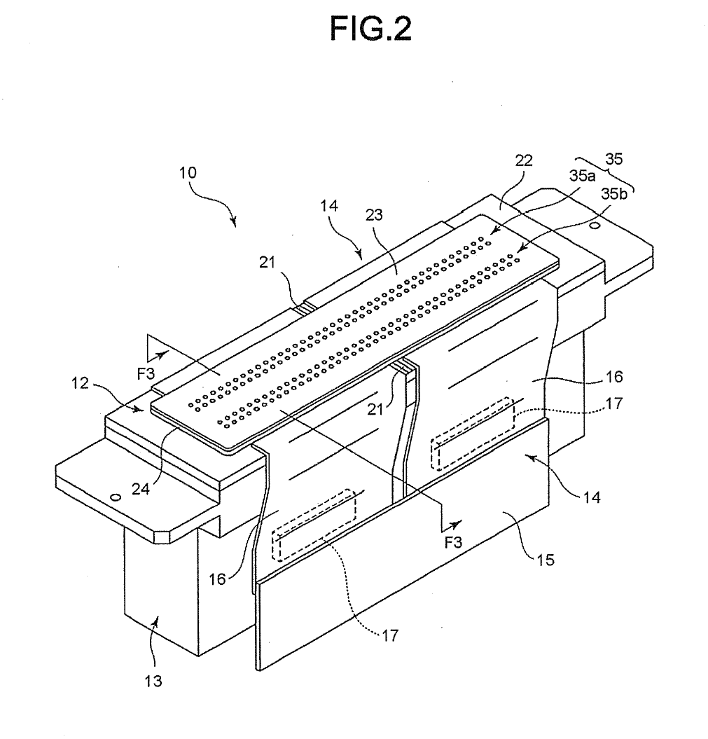

Next, the inkjet head 10 is described. Examples of the configuration of the inkjet head 10 are described hereinafter with reference to FIG. 2 to FIG. 9. The inkjet head 10 receives the supply of the ink (print member) from the inkjet printer 100 to form an image on the paper P as the print medium. The print member may be various kinds of ink for forming images. Further, the print member may be functional ink including various functions used except the use of forming an image.

The inkjet head 10 is connected with a tank (ink tank or liquid tank) loaded in the inkjet printer 100 via a tube. The inkjet head 10 receives the supply of the ink from the tank via the tube.

The inkjet head 10 is equipped with a head main body 12, a unit section 13 and a control circuit 14 (controller or control section). The head main body 12 is formed on the unit section 13. The control circuit 14, which is arranged on the side surface of the unit section 13, sends a control signal to the head main body 12. The unit section 13 includes a manifold for forming a part of a route between the head main body 12 and the tank and a member for connecting with the inkjet printer 100.

As shown FIG. 2, the control circuit 14 includes a substrate main body 15 and a pair of film carrier packages (FOP) 16. The substrate main body 15 is a rectangular printed wiring board. Various electronic components and connectors are mounted in the substrate main body 15. Further, a pair of the FCPs 16 is mounted in the substrate main body 15.

Each of the pair of the FCPs 16 on which a plurality of wirings is formed includes a film made of resin having softness and an IC 17 connected with a plurality of the wirings. The film is tape automated bonding (TAB). The pair of the FCPs 16 is mounted from the substrate main body 15 along the side surface of the unit section 13 and connected with the head main body 12. The IC 17 is a member for applying a voltage to an electrode 34. The IC 17 is fixed on the film through the resin.

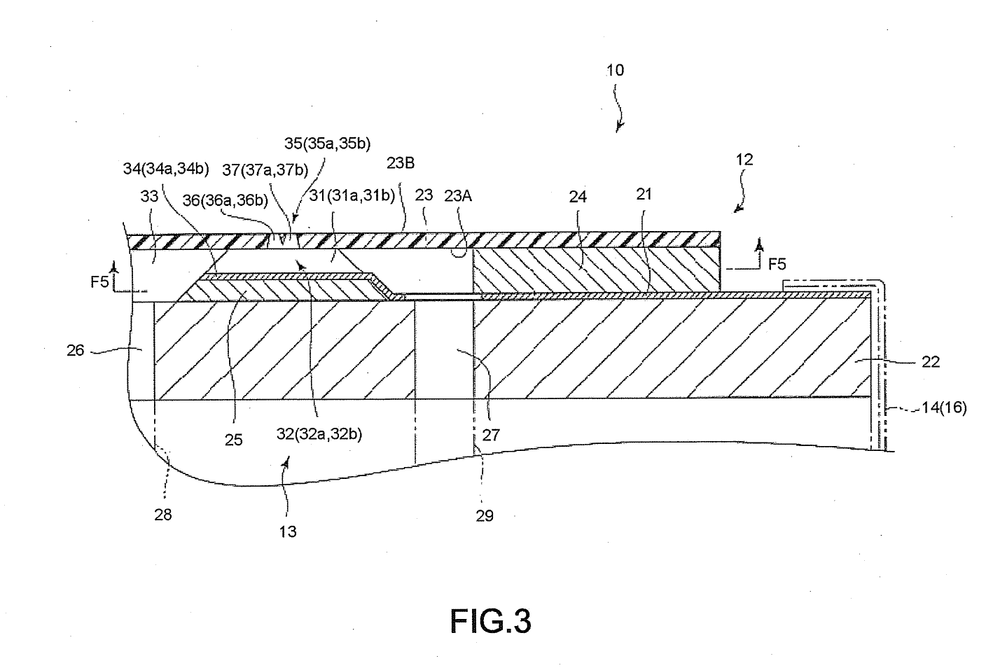

FIG. 3 is a cross-sectional view of the inkjet head taken along a F3-F3 line according to the first embodiment. As shown in FIG. 3, an end part of the FCP 16 is connected with a wiring pattern 21 on a base plate 22 by thermocompression bonding through an anisotropic conductive film (ACF). Through the ACF, a plurality of wirings of the FCP 16 is electrically connected with the wiring pattern 21.

The head main body 12 ejects a liquid drop (ink drop) onto the print medium (paper P). As shown in FIG. 3, the head main body 12 is equipped with the base plate 22, a nozzle plate 23, a frame member 24 and a block 25 in which a plurality of driving elements 31 is formed.

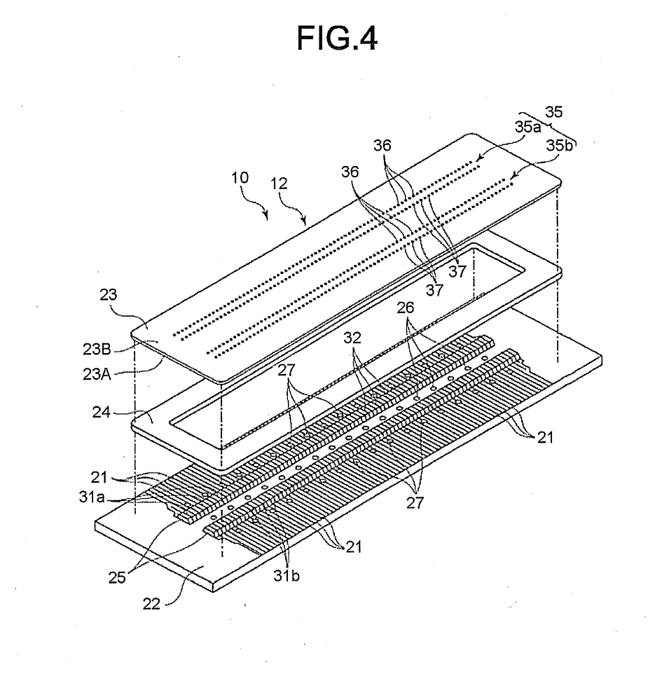

As shown in FIG. 3 and FIG. 4, the base plate 22 is formed into a rectangular plate shape. The base plate 22 is made from, for example, ceramic like alumina. A plurality of supply holes 26 and a plurality of discharge holes 27 penetrate the base plate 22.

The supply holes 26 can be parallelly arranged substantially at the center of the base plate 22 in a longitudinal direction of the base plate 22. The supply hole 26 communicates with an ink supply section 28 of the manifold of the unit section 13. The supply hole 26 is connected with the tank via the ink supply section 28.

The discharge holes 27 are parallelly arranged at two sides of the base plate 22 across the supply hole 26 in the longitudinal direction of the base plate 22. The discharge hole 27 communicates with an ink discharge section 29 of the manifold of the unit section 13. The discharge hole 27 is connected with the tank via the ink discharge section 29.

The frame member 24 can be a square frame-shaped member. The frame member 24 is made from, for example, nickel alloy. The frame member 24 intermediates between the base plate 22 and the nozzle plate 23. The frame member 24 is respectively bonded with a mounting surface and the nozzle plate 23.

The driving element 31 is formed by two piezoelectric bodies. The driving element 31 includes two plate-like piezoelectric bodies formed by, for example, lead zirconate titanate (PZT). The two piezoelectric bodies are bonded with each other in such a manner that their directions of polarization are opposite to each other in the thickness direction.

The block 25 in which a plurality of the driving elements 31 is formed is bonded on the mounting surface of the base plate 22. As shown in FIG. 3, the block 25 is formed into a trapezoid. The top of the driving element 31 is bonded with the nozzle plate 23.

As shown in FIG. 4, the block 25 includes a plurality of grooves. The grooves respectively extend in a direction crossing with the longitudinal direction of the block 25 (longitudinal direction of the inkjet head 10). The plate-like driving elements 31 are separated by the grooves.

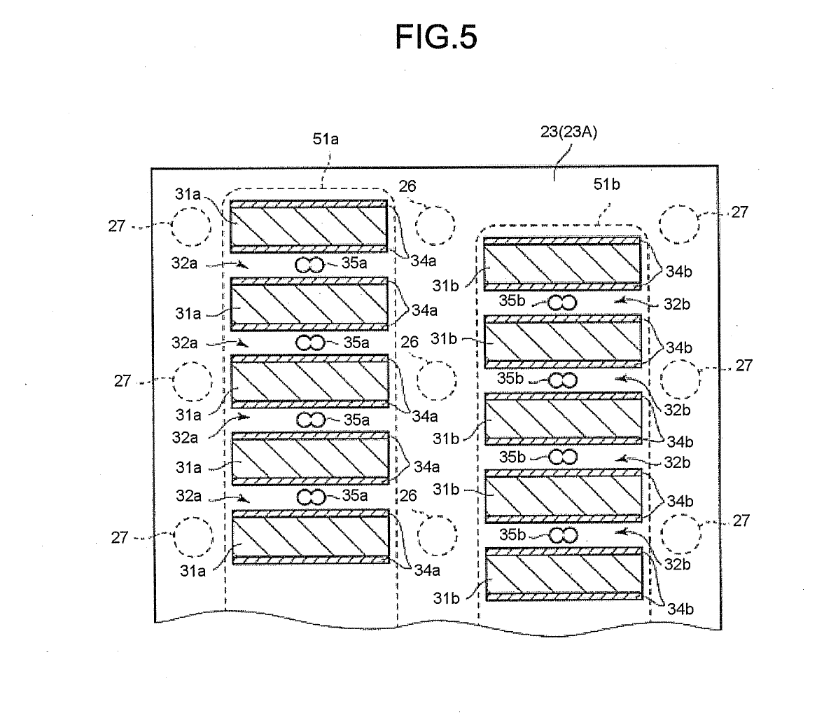

FIG. 5 is a cross-sectional view of the inkjet head 10 taken along a F5-F5 line. As shown in FIG. 5, the electrode 34 is arranged on both surfaces of the driving element 31. The electrode 34 covers the bottom of the groove (pressure chamber 32) and side surfaces of the driving element 31. The electrode 34 is formed by, for example, carrying out laser patterning on nickel thin film. The electrode 34 is electrically connected with the IC 17.

As shown in FIG. 4, a plurality of the wiring patterns 21 extending in a direction crossing with the longitudinal direction of the base plate 22 from a plurality of the driving elements 31 is arranged on the mounting surface of the base plate 22. The wiring pattern 21 is formed by, for example, carrying out the laser patterning on the nickel thin film formed on the base plate 22.

The nozzle plate 23 is formed with, for example, polyimide film, and is substantially rectangular. The nozzle plate 23 faces the base plate 22. The nozzle plate 23 includes a first surface 23A (pressure chamber surface) at a pressure chamber 32 side and a second surface 23B (outer surface) opposite to the first surface 23A.

The nozzle plate 23 includes an integrated nozzle 35. The integrated nozzle 35 penetrates the nozzle plate 23. The integrated nozzle 35 is composed of a first integrated nozzle 35a and a second integrated nozzle 35b. The first integrated nozzle 35a and the second integrated nozzle 35b are respectively composed of at least two nozzles. In other words, the first integrated nozzle 35a is composed of at least two of the nozzles formed in the nozzle plate 23. Further, the second integrated nozzle 35b is composed of at least two of the other nozzles formed in the nozzle plate 23. The number of the nozzles constituting the integrated nozzle 35 is not specifically limited. In the example shown in FIG. 4, the first integrated nozzle 35a and the second integrated nozzle 35b are respectively composed of two nozzles arranged in parallel in a lateral direction of the nozzle plate 23.

The nozzle plate 23 includes a plurality of the first integrated nozzles 35a and a plurality of the second integrated nozzles 35b. A plurality of the first integrated nozzles 35a and a plurality of the second integrated nozzles 35b are respectively arranged in parallel along the longitudinal direction of the nozzle plate 23.

An area inside the groove arranged in the block 25 is the pressure chamber 32 facing a first nozzle 36 and a second nozzle 37 described later. A driving element 31 enables the liquid drops to be simultaneously ejected from the first nozzle 36 and the second nozzle 37 described later. A common liquid chamber 33 supplies the liquid (ink) to each pressure chamber 32. As shown in FIG. 3, the common liquid chamber 33 is composed of the nozzle plate 23, a part of the base plate 22 in the vicinity of the supply hole 26 and the inclined plane portion of the block 25. The common liquid chamber 33 communicates with each pressure chamber 32.

As shown in FIG. 4 and FIG. 5, each integrated nozzle 35 includes the first nozzle 36 and the second nozzle 37. The second nozzle 37 is arranged in the vicinity of the first nozzle 36 adjacent to the first nozzle 36 in the lateral direction of the nozzle plate 23. The first nozzle 36 and the second nozzle 37 face the same pressure chamber 32.

As shown in FIG. 5, the inkjet head 10 is equipped with two rows (a plurality of rows) of driving elements 31 including one row of plural driving elements 31a and one row of plural driving elements 31b, arranged in one direction, which are parallel to each other. In FIG. 5, the inkjet head 10 is equipped with the driving elements 31a as the row at the left side and the driving elements 31b as the row at the right side. The longitudinal direction of the driving element 31 has an orthogonal relation to an arrangement direction of the driving element; however, the longitudinal direction of the driving elements 31 may have a predetermined angle to the arrangement direction. Furthermore, the plural nozzles of the integrated nozzle 35 are arranged in a direction parallel to the longitudinal direction of the driving elements.

Two rows of ejection areas 51a and 51b are formed in parallel at both sides of the supply hole 26. The ejection area 51a is a first ejection area, and the ejection area 51b is a second ejection area. The ejection area 51a and the ejection area 51b are arranged at a predetermined interval. The ejection area 51a includes a plurality of the driving elements 31a, the electrodes 34a and the first integrated nozzles 35a. The ejection area 51b includes a plurality of the driving elements 31b, the electrodes 34b and the second integrated nozzles 35b.

The pressure chamber 32 (32a or 32b) is formed between the driving elements 31 (31a or 31b). The pressure chamber 32 is formed by two driving elements 31 and the electrodes 34 (34a or 34b) arranged on two surfaces of the driving element 31. The integrated nozzle 35 for ejecting the ink is arranged substantially at the center of the longitudinal direction of the pressure chamber 32 on the nozzle plate 23. The longitudinal direction of the pressure chamber 32 is orthogonal to the arrangement direction of the driving element 31. The common liquid chamber 33 is arranged between the ejection area 51a and the ejection area 51b. The discharge hole 27 at one end side of the ejection area 51a and the supply hole 26 at the other end side thereof are arranged on the base plate 22. The supply hole 26 at one end side of the ejection area 51b and the discharge hole 27 at the other end side thereof are arranged on the base plate 22. A plurality of the supply holes 26 is arranged in the arrangement direction of the driving element 31. A plurality of rows of the plural discharge holes 27 is arranged in the arrangement direction of the driving element 31. The discharge hole 27 is arranged in the vicinity of the frame member 24.

The first integrated nozzle 35a communicates with the pressure chamber 32a (first pressure chamber) formed by the driving elements 31a (first driving elements) and the electrodes 34a arranged on the both surfaces of the driving element 31a. Further, the second integrated nozzle 35b communicates with the pressure chamber 32b (second pressure chamber) formed by the driving elements 31b (second driving elements) and the electrodes 34b arranged on the both surfaces of the driving element 31b.

The first integrated nozzle 35a in the ejection area 51a and the second integrated nozzle 35b in the ejection area 51b are not arranged collinearly with respect to a direction orthogonal to the arrangement direction of the driving element 31. In other words, the first integrated nozzle 35a in the ejection area 51a and the second integrated nozzle 35b in the ejection area 51b are arranged at positions different from each other with respect to the arrangement direction of the driving element 31.

Next, the first integrated nozzle 35a and the second integrated nozzle 35b are described. Herein, the configuration of the first integrated nozzle 35a is described. As the configuration of the second integrated nozzle 35b is the same as that of the first integrated nozzle 35a, the description thereof is omitted.

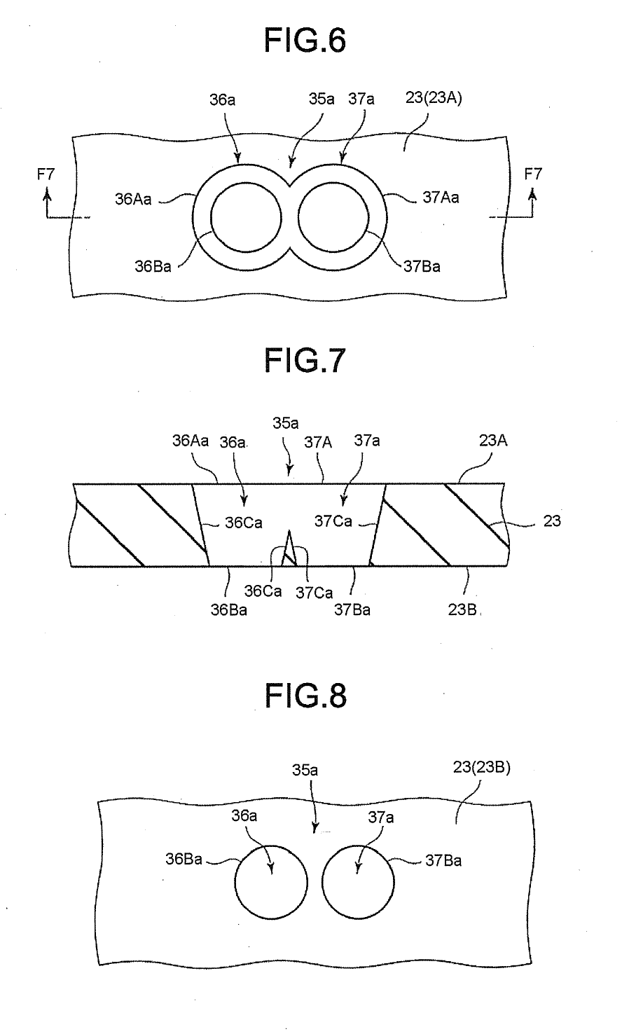

FIG. 6 is a diagram illustrating an example of a first surface 23A of the nozzle plate 23. FIG. 7 is a cross-sectional view illustrating of the nozzle plate 23 taken along a F7-F7 line. FIG. 8 is a diagram illustrating an example of a second surface 23B of the nozzle plate 23.

As shown in FIG. 7, the first integrated nozzle 35a is equipped with a first nozzle 36a and a second nozzle 37a. The first nozzle 36a and the second nozzle 37a have the same shape. The first nozzle 36a and the second nozzle 37a are formed into, for example, a trapezoid the diameter of which becomes small with approaching the second surface 233. The first integrated nozzle 35a penetrates the first surface 23A and the second surface 23B. The first nozzle 36a includes a first opening 36Aa arranged on the first surface 23A and a second opening 36Ba arranged on the second surface 23B. The second nozzle 37a includes a third opening 37Aa arranged on the first surface 23A and a fourth opening 37Ba arranged on the second surface 23B.

A first peripheral surface 36Ca (inner peripheral surface, side surface and inclined surface) of the first nozzle 36a linearly extends from the second surface 23B towards the first surface 23A. The first peripheral surface 36Ca (inner peripheral surface, side surface and inclined surface) of the first nozzle 36a crosses with a second peripheral surface 37Ca (inner peripheral surface, side surface and inclined surface) of the second nozzle 37a linearly extending from the second surface 23B towards the first surface 23A en route from the second surface 23B to the first surface 23A.

As shown in FIG. 6, a part of the first opening 36Aa is overlapped with a part of the third opening 37Aa. In other words, the first opening 36Aa and the third opening 37Aa are consecutively arranged. Thus, as shown in FIG. 7, a part of the first nozzle 36a at the first surface 23A side communicates with a part of the second nozzle 37a at the first surface 23A side to be integrated.

As shown in FIG. 8, the second opening 36Ba is separated from the fourth opening 37Ba but arranged in the vicinity of the fourth opening 37Ba. Thus, a part of the first nozzle 36a at the second surface 23B side is separated from a part of the second nozzle 37a at the second surface 23B side.

The second integrated nozzle 35b is equipped with a third nozzle 36b and a fourth nozzle 37b. The third nozzle 36b is equipped with a fifth opening 36Ab and a sixth opening 36Bb. The fourth nozzle 37b is equipped with a seventh opening 37Ab and an eighth opening 37Bb. The third nozzle 36b, the fourth nozzle 37b, the fifth opening 36Ab, the sixth opening 36Bb, the seventh opening 37Ab and the eighth opening 37Bb are respectively the same as the first nozzle 36a, the second nozzle 37a, the first opening 36Aa, the second opening 36Ba, the third opening 37Aa and the fourth opening 37Ba, and thus, the description thereof is omitted.

Furthermore, the first nozzle 36a and the second nozzle 37a may be independent of each other without communicating with each other. In other words, the first nozzle 36a and the second nozzle 37a do not communicate with each other at the first surface 23A side, at the second surface 23B side and between the two surfaces. Similarly, the third nozzle 36b and the fourth nozzle 37b may be independent of each other without communicating with each other. In other words, the third nozzle 36b and the fourth nozzle 37b do not communicate with each other at the first surface 23A side, at the second surface 23B side and between the two surfaces.

In the inkjet head 10, partition may be arranged between each pressure chamber 32 in the ejection area 51a and each pressure chamber 32 in the ejection area 51b. In this case, the inkjet head 10 is equipped with the supply holes respectively at the ejection area 51a side and at the ejection area 51b side. The two supply holes communicate with the same common ink chamber. The common ink chamber may be formed at back surface side (in other words, outer surface side of the base plate 22) of the pressure chamber 32. The shape and position of the common ink chamber are not limited to a specific configuration.

Next, ejection operations of the ink by the inkjet head 10 are described. The inkjet head 10 is a liquid (ink) circulation type inkjet head 10. The ink ejected from the tank is supplied to the pressure chamber 32 (32a and 32b) via the supply hole 26 and the common liquid chamber 33. The ink which is not ejected in the pressure chamber 32 is collected from the discharge hole 27 to the tank. In this way, in the inkjet head 10, the ink is circulated between the tank and the inside of the inkjet head 10.

The ejection operations of the first integrated nozzle 35a and the second integrated nozzle 35b are identical, and thus, only the ejection operations of the first integrated nozzle 35a are described hereinafter and the ejection operations of the second integrated nozzle 35b are omitted.

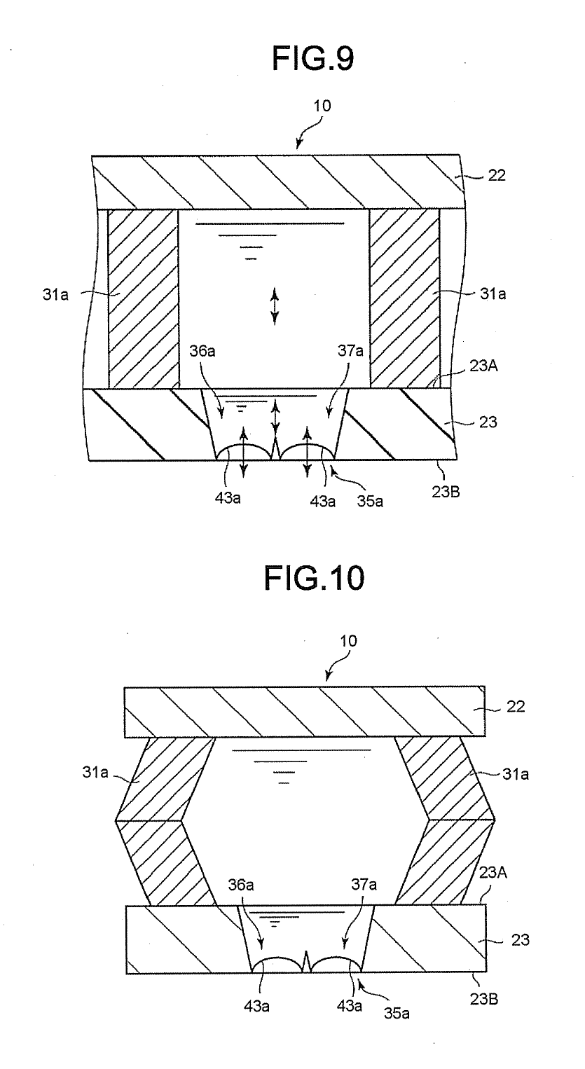

FIG. 9 is a cross-sectional view of the pressure chamber 32a along the thickness direction of the nozzle plate 23. The control circuit 14 drives the driving element 31a to increase or decrease the volume of the pressure chamber 32a in order to enable the ink to be ejected from the first integrated nozzle 35a. The control circuit 14 applies a voltage to the electrode 34a to drive the driving element 31a to increase or decrease the volume of the pressure chamber 32a.

FIG. 10 is a diagram illustrating a state in which the control circuit 14 drives the driving element 31a so as to increase the volume of the pressure chamber 32a. For example, the control circuit 14 applies a pulse (expansion pulse) which expands the volume of the pressure chamber 32a to the driving element 31a. If the control circuit 14 applies the expansion pulse to the driving element 31a, as shown in FIG. 10, the driving element 31a deforms towards the outer side of the pressure chamber 32a. As a result, the volume of the pressure chamber 32a is increased compared with the initial state (state in FIG. 9)

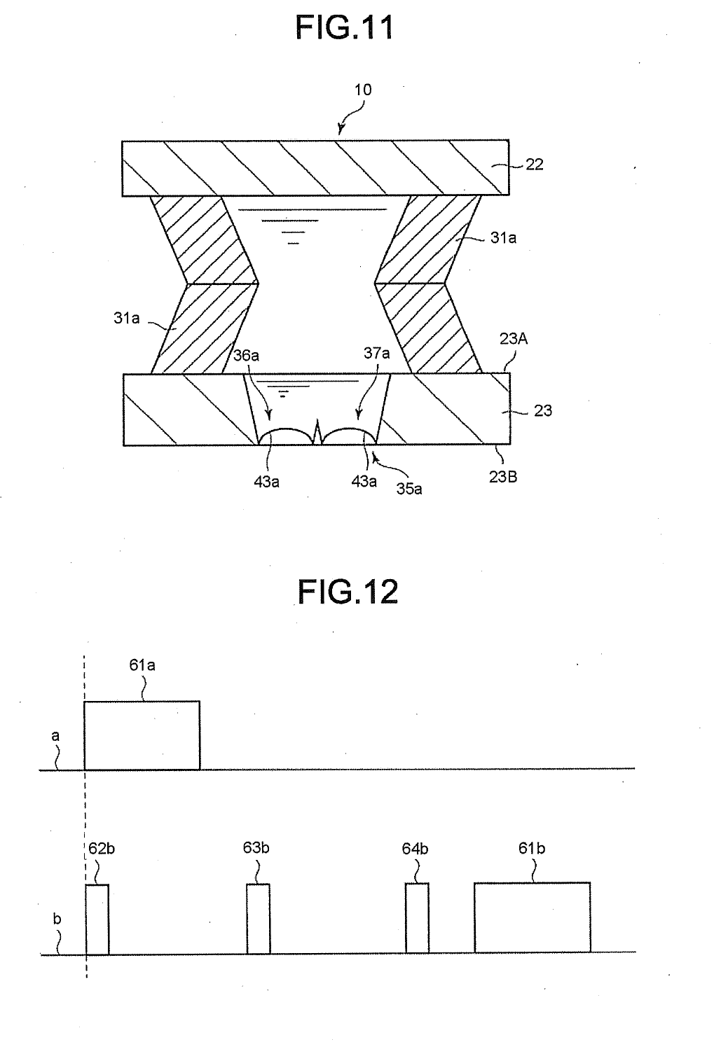

FIG. 11 is a diagram illustrating a state in which the control circuit 14 drives the driving element 31a so as to decrease the volume of the pressure chamber 32a. For example, the control circuit 14 applies a pulse (contraction pulse) which contracts the volume of the pressure chamber 32a to the driving element 31a. If the control circuit 14 applies the contraction pulse to the driving element 31a, as shown in FIG. 11, the driving element 31a deforms towards the inside of the pressure chamber 32a. As a result, the volume of the pressure chamber 32a is decreased compared with the initial state (state in FIG. 9).

After the control circuit 14 temporarily increases the volume of the pressure chamber 32a, if the volume of the pressure chamber 32a is smaller than the original volume, the liquid in the pressure chamber 32a is pressurized, and the ink from the first nozzle 36a and the second nozzle 37a is simultaneously ejected. In other words, the control circuit 14 applies an ejection pulse composed of the expansion pulse and the contraction pulse to the electrode 34 of the driving element 31a to enable the ink to be ejected. Further, the waveform of the ejection pulse may be, for example, a waveform changing at a plurality of stages or a rectangular waveform. The configuration of the ejection pulse is not limited to the specific configuration.

Just before the ejection of the ink, meniscus surfaces 43a of the first nozzle 36a and the second nozzle 37a protrude towards the external. The ejected ink is ejected as the liquid drop towards the print medium. After the liquid drop is ejected, the meniscus surface 43a of the first nozzle 36a and the meniscus surface 43a of the second nozzle 37a retreat towards the inside of the first nozzle 36a and the second nozzle 37a.

Next, an example of operations of the control circuit 14 is described. As shown in FIG. 5, the control circuit 14 sets the ejection area 51a and the ejection area 51b. The ejection area 51a includes one row of the first integrated nozzles 35a (e.g., a row at the left side of FIG. 5) which are arranged in the longitudinal direction of the nozzle plate 23. Similarly, the ejection area 51b includes a row of the second integrated nozzles 35b (e.g., a row at the right side of FIG. 5) arranged in the longitudinal direction of the nozzle plate 23.

The control circuit 14 enables the ink to be ejected from the integrated nozzle 35 in each ejection area. For example, at the time the print medium passes from the ejection area 51a side, the control circuit 14 enables the ink to be ejected from the ejection area 51a, and sequentially enables the ink to be ejected from the ejection area 51b.

Further, the control circuit 14 sets a channel No for each pressure chamber 32 (channel) in the predetermined ejection areas 51a and 51b. For example, the control circuit 14 sets the channel No of each pressure chamber 32 in order from one end of the nozzle plate 23.

The pressure chamber 32 shares the driving element 31 with the respectively adjacent pressure chambers 32. Thus, the control circuit 14 cannot drive each pressure chamber 32 at the same time. Consequently, the control circuit 14 divides the pressure chambers 32 into a plurality of groups every n+1 (n is an integer equal to or greater than 2) channels to drive each group (division) In the embodiment, the control circuit 14 divides the pressure chambers 32 into three groups every three channels to carry out division driving, in other words, a case of three division driving is exemplified.

The control circuit 14 divides the pressure chambers 32 into No. 3n−2 channel group (first division), No. 3n−1 channel group (second division) and No. 3n channel group (third division) (n is an integer equal to or greater than 1). For example, the control circuit 14 enables the ink to be ejected in the order of the first division, the second division and the third division.

Further, the control circuit 14 may adopt a method (Multi-drop drive) for enabling the ink to be continuously ejected from one channel for many times. For example, the control circuit 14 controls the times that the ink is continuously ejected in response to print data.

Next, the pulse applied to the channel by the control circuit 14 is described. FIG. 12 is a timing chart illustrating an example of the pulse applied to the channel by the control circuit 14. The control circuit 14 enables the ink to be ejected from a predetermined division of the ejection area 51b after enabling the ink to be ejected from a predetermined division of the ejection area 51a.

A waveform a exemplifies a pulse applied to a predetermined division (division a) of the ejection area 51a. A waveform b exemplifies a pulse applied to a division (division b) of the ejection area 51b corresponding to the predetermined division of the ejection area 51a.

As shown in FIG. 12, the control circuit 14 applies an ejection pulse 61a to the division a at a predetermined timing. Further, the control circuit 14 sequentially applies non-ejection pulses 62b to 64b to the division b and then applies the ejection pulse 61b thereto.

The non-ejection pulse is a signal which does not lead to the ejection of the ink. In other words, the non-ejection pulse is a signal which enables the pressure chamber 32 to generate vibration but does not lead to the ejection of the ink. For example, the non-ejection pulse is a signal of which a voltage is smaller than that of the ejection pulse. Further, the non-ejection pulse is a signal of which a width is smaller than that of the ejection pulse. For example, the non-ejection pulse is a rectangular pulse wave. The waveform of the non-ejection pulse is not limited to the specific configuration. In the present embodiment, the non-ejection pulse is set to the rectangular pulse wave. Furthermore, the non-ejection pulse is set to a pulse wave shorter than the ejection pulse.

The control circuit 14 applies at least one non-ejection pulse to the division b until the application of the ejection pulse to the division a is ended. In other words, the control circuit 14 applies a non-ejection pulse to the division b of which the application is ended until an end timing at which the application of the ejection pulse to the division a is ended.

In the example shown in FIG. 12, the control circuit 14 starts to apply the non-ejection pulse 62b to the division b at a timing when the application of the ejection pulse 61a to the division a is started. In other words, the control circuit 14 makes the timing of the start of the ejection pulse 61a of the division a consistent with the timing of the start of the non-ejection pulse 62b of the division b.

After applying the non-ejection pulse 62b to the division b, the control circuit 14 applies the non-ejection pulse 63b to the division b at a predetermined interval. After applying the non-ejection pulse 63b to the division b, the control circuit 14 applies the non-ejection pulse 64b to the division b at a predetermined interval. After applying the non-ejection pulse 64b to the division b, the control circuit 14 applies the ejection pulse 61b to the division b at a predetermined interval.

The interval between the non-ejection pulse 62b and the non-ejection pulse 63b may be identical to or different from that between the non-ejection pulse 63b and the non-ejection pulse 64b. The control circuit 14 may apply three or more non-ejection pulses or only one non-ejection pulse between the non-ejection pulse 62b and the ejection pulse 61b. Further, the control circuit 14 may not apply a non-ejection pulse between the non-ejection pulse 62b and the ejection pulse 61b. Further, the control circuit 14 may apply a non-ejection pulse prior to the non-ejection pulse 62b.

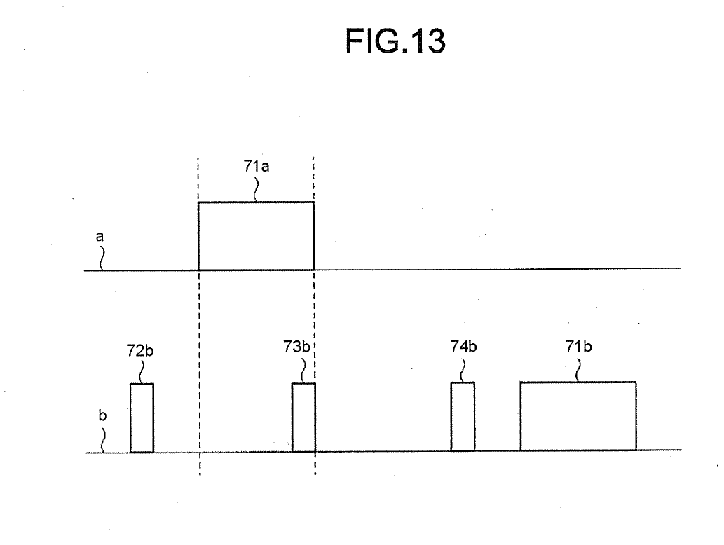

Next, another example of the pulse applied to the channel by the control circuit 14 is described. FIG. 13 is a timing chart illustrating another example of the pulse applied to the channel by the control circuit 14. The control circuit 14 enables the ink to be ejected from the predetermined division of the ejection area 51b after enabling the ink to be ejected from the predetermined division of the ejection area 51a.

As shown in FIG. 13, the control circuit 14 applies an ejection pulse 71a to the division a at a predetermined timing. Further, the control circuit 14 sequentially applies non-ejection pulses 72b to 74b to the division b, and then applies an ejection pulse 71b thereto.

In the example shown in FIG. 13, the control circuit 14 applies the non-ejection pulse 72b to the division b at a predetermined timing before applying the ejection pulse 71a to the division a. If the non-ejection pulse 72b is applied to the division b, the control circuit 14 applies the non-ejection pulse 73b of which the application is ended at the same timing as the end of the application of the ejection pulse 71a to the division a. In other, words, the control circuit 14 makes the timing of the falling of the ejection pulse 71a of the division a consistent with the timing of the falling of the non-ejection pulse 73b.

If the non-ejection pulse 73b is applied to the division b, the control circuit 14 applies a non-ejection pulse 74b to the division b at a predetermined interval. If a non-ejection pulse 74b is applied to the division b, the control circuit 14 applies the ejection pulse 71b to the division b at a predetermined interval.

The interval between the non-ejection pulse 72b and the non-ejection pulse 73b may be identical to or different from that between the non-ejection pulse 73b and the non-ejection pulse 74b. The control circuit 14 may apply two or more non-ejection pulses or may not apply any non-ejection pulse between the non-ejection pulse 73b and the ejection pulse 71b. The control circuit 14 may apply two or more non-ejection pulses or may not, apply any non-ejection pulse before the non-ejection pulse 73b. Further, the control circuit 14 may apply a plurality of non-ejection pulses to the division b while an ejection pulse is applied to the division a.

Next, the pulses applied to each division of the ejection area 51a and each division of the ejection area 51b by the control circuit 14 are described.

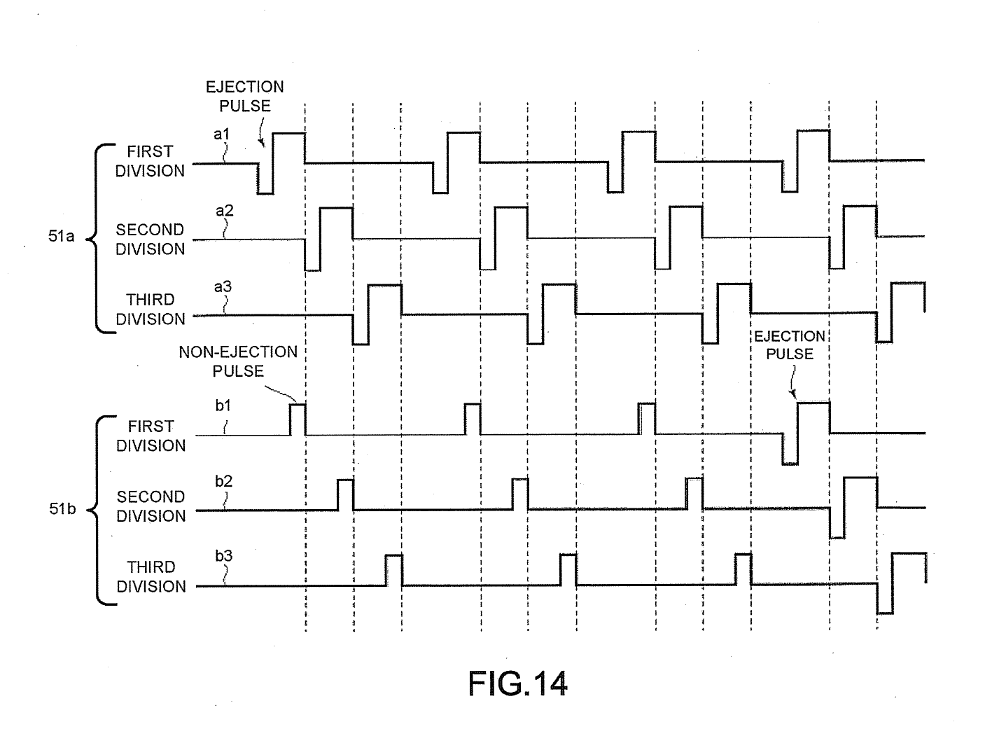

FIG. 14 is a timing chart for describing a concrete example of the pulses applied to each division of the ejection area 51a and each division of the ejection area 51b by the control circuit 14. FIG. 14 illustrates an example (example shown in FIG. 13) in which a timing at which the ejection pulse is ended is consistent with a timing at which the non-ejection pulse is ended.

It is assumed that the control circuit 14 enables the ink to be ejected from each division of the ejection area 51a, and next enables the ink to be ejected from each division of the ejection area 51a and each division of the ejection area 51b. The control circuit 14 enables the ink to be ejected from the first division, the second division and the third division in order.

In FIG. 14, a waveform a1 illustrates an example of a pulse applied to the first division of the ejection area 51a. A waveform a2 illustrates an example of a pulse applied to the second division of the ejection area 51a. A waveform a3 illustrates an example of a pulse applied to the third division of the ejection area 51a. A waveform b1 illustrates an example of a pulse applied to the first division of the ejection area 51b. A waveform b2 illustrates an example of a pulse applied to the second division of the ejection area 51b. A waveform b3 illustrates an example of a pulse applied to the third division of the ejection area 51b.

As shown in FIG. 14, firstly, the control circuit 14 applies an ejection pulse to the first division of the ejection area 51a. Further, the control circuit 14 applies a non-ejection pulse to the first division of the ejection area 51b of which the application is ended at the same timing as the end of the application of the ejection pulse.

If the ejection pulse is applied to the first division of the ejection area 51a and the non-ejection pulse is applied to the first division of the ejection area 51b, the control circuit 14 applies an ejection pulse to the second division of the ejection area 51a. Further, the control circuit 14 applies a non-ejection pulse to the second division of the ejection area 51b of which the application is ended at the same timing as the end of the application of the ejection pulse.

If the ejection pulse is applied to the second division of the ejection area 51a and the non-ejection pulse is applied to the second division of the ejection area 51b, the control circuit 14 applies an ejection pulse to the third division of the ejection area 51a. Further, the control circuit 14 applies a non-ejection pulse to the third division of the ejection area 51b of which the application is ended at the same timing as the end of the application of the ejection pulse.

Similarly, the control circuit 14 applies the ejection pulses to the first division, the second division and the third division of the ejection area 51a. Further, similarly, the control circuit 14 applies the non-ejection pulse to the first division, the second division and the third division of the ejection area 51b.

Further, the control circuit 14 simultaneously applies the ejection pulse to the first division of the ejection area 51b and the ejection pulse to the first division of the ejection area 51a at a predetermined timing. For example, the control circuit 14 applies the ejection pulses to the first divisions of both ejection areas at a timing when the paper P is conveyed to a position where the ejection area 51b ejects the ink. If the ejection pulses are applied to the first divisions of both ejection areas, the control circuit 14 applies the ejection pulses to the second divisions of both ejection areas. If the ejection pulses are applied to the second divisions of both ejection areas, the control circuit 14 applies the ejection pulses to the third divisions of both ejection areas.

Furthermore, the control circuit 14 may not apply the ejection pulse to a predetermined division of the ejection area 51a at a predetermined timing. For example, the control circuit 14 may apply a non-ejection pulse to the predetermined division of the ejection area 51a before an end timing of the ejection pulse applied to a predetermined division of the ejection area 51b.

In a case in which ink drops are ejected the number of which meets the maximum ejection number from a predetermined channel, the control circuit 14 may apply the non-ejection pulse to an empty part of the ejection pulse (in other words, at the timing of applying the ejection pulse in a case of ejecting the maximum ejection number). Further, the control circuit 14 may apply the non-ejection pulse to a part of the empty part.

Next, a relation between a width of the non-ejection pulse and ejection failure is described.

Firstly, ejection failure generated in the inkjet head 10 is described.

According to the embodiment, the inkjet head 10 is equipped with the ejection areas 51a and 51b. The inkjet head 10 ejects the ink ahead from either of the ejection areas 51a and 51b. If the inkjet head 10 ejects the ink from an initial ejection area (for example, the ejection area 51a), pressure (nozzle negative pressure) of the pressure chamber 32 of the ejection area, the common liquid chamber 33 communicating with the pressure chamber and the pressure chamber 32 of the other ejection area (for example, the ejection area 51b) communicating with the common liquid chamber 33 is reduced.

In a case of ejecting the ink from the ejection area 51b after ejecting the ink from the ejection area 51a, the inkjet head 10 ejects the ink from the ejection area 51b inmost cases in a state in which the nozzle negative pressure is lower than that before the ejection of the ink. If the inkjet head 10 ejects the ink in a state in which the nozzle negative pressure is lower, the first ejection failure (for example, blurring or decrease in an ejection volume) occurs in most cases. In other words, the inkjet head 10 is easy to generate the first ejection failure if the nozzle negative pressure before the ejection of the ink is low.

Further, in a case in which there is a plurality of nozzles (the first nozzle 36 and the second nozzle 37) with respect to one pressure chamber 32, the second ejection failure (e.g., blurring) occurs in most cases. If the nozzle negative pressure is high, the second ejection failure occurs. In other words, the inkjet printer 10 is easy to generate the second ejection failure if the nozzle negative pressure before the ejection of the ink is high.

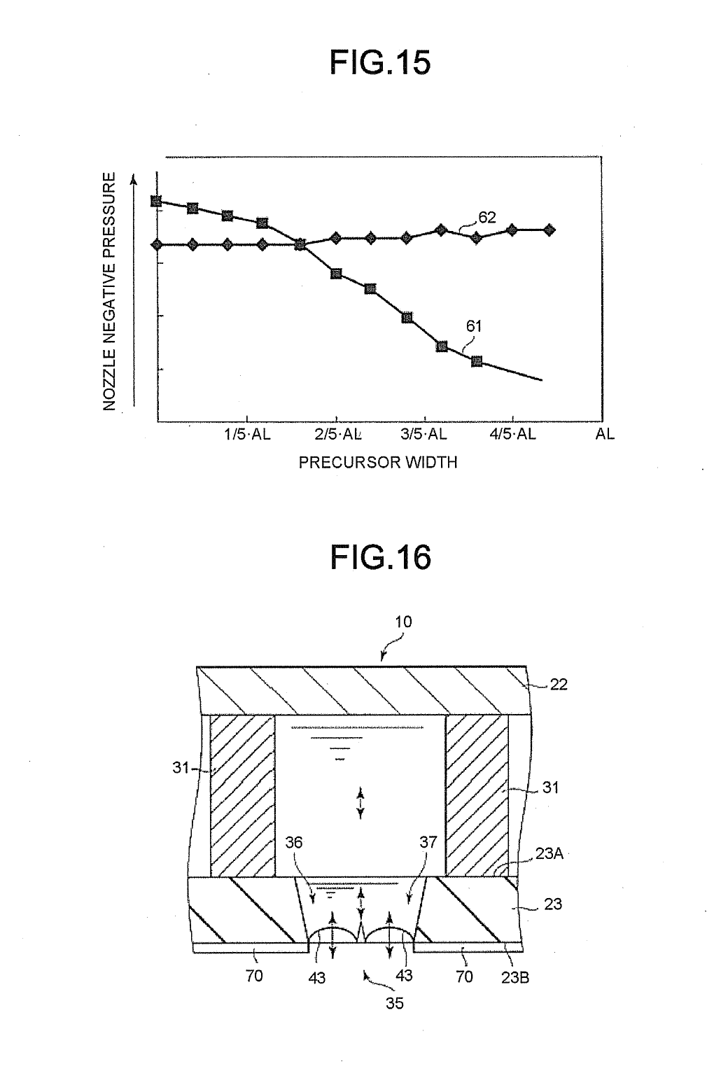

FIG. 15 is a diagram illustrating a relation between a non-ejection pulse width and the ejection failure. The horizontal axis in FIG. 15 indicates the width of the non-ejection pulse. AL refers to time equivalent to half of the natural vibration period in which the nozzle negative pressure changes. The vertical axis in FIG. 15 indicates the nozzle negative pressure before the ejection.

A graph 61 shown in FIG. 15 indicates the nozzle negative pressure at which the first ejection failure occurs. In other words, if the nozzle negative pressure is lower than the graph 61 (a case of being at the lower side of the graph 61), the first ejection failure occurs. Contrarily, if the nozzle negative pressure is higher than the graph 61 (a case of being at the upper side of the graph 61), the first ejection failure does not occur.

A graph 62 shown in FIG. 15 indicates the nozzle negative pressure at which the second ejection failure occurs. In other words, if the nozzle negative pressure is higher than the graph 62 (a case of being at the upper area of the graph 62), the second ejection failure occurs. Contrarily, if the nozzle negative pressure is lower than the graph 62 (a case of being at the lower area of the graph 62), the first ejection failure does not occur.

The nozzle negative pressure and the width of the non-ejection pulse at which the first and the second ejection failure does not occur are at the upper area of the graph 61 and at the lower area of the graph 62. As shown in FIG. 15, if the width of the non-ejection pulse is longer than or equal to ⅓AL, the inkjet head 10 can set the nozzle negative pressure at which the first and the second ejection failure does not occur.

Next, another embodiment relating to the inkjet head 10 according to the first embodiment is described. FIG. 16 is a diagram for illustrating another embodiment. The inkjet head 10 according to another embodiment is further equipped with a liquid repellent layer 70. The other points of the inkjet head 10 according to another embodiment are the same as those of the inkjet head 10 according to the first embodiment, and thus, the same symbols are assigned thereto and the description thereof is omitted.

The liquid repellent layer 70 is formed on the second surface 23B. The liquid repellent layer 70 is at least formed around the integrated nozzle 35 on the second surface 23B. The liquid repellent layer 70 is formed by material having a liquid repellent property. The thickness of the liquid repellent layer 70 is, for example, equal to or smaller than 1 μm.

The liquid repellent layer 70 is formed by, for example, fluorine or silica-based material. The material or the shape of the liquid repellent layer 70 is not limited to a specific configuration. The liquid repellent layer 70 is formed by, for example, executing vapor deposition on the second surface 23B.

The inkjet head with the foregoing structure can apply the non-ejection pulse to the channel of the ejection area where the ink is not ejected at a timing when the ejection pulse is applied. As a result, the inkjet head can suppress the ejection failure (the first ejection failure) generated due to decrease of the nozzle negative pressure. As the negative pressure setting can be lowered through applying the non-ejection pulse, the inkjet head can also suppress the ejection failure (the second ejection failure) generated in a case in which there is a plurality of nozzles (the first nozzle 36 and the second nozzle 37) with respect to one pressure chamber 32. Thus, the inkjet head can set the nozzle negative pressure at which the first and the second ejection failure does not occur through applying the non-ejection pulse. Thus, the inkjet head can suppress the ejection failure.

The inkjet head easily generates the second ejection failure if the ink adheres to the vicinity of the nozzle. The inkjet head according to the embodiment forms the liquid repellent layer having the liquid repellent property in the vicinity of the nozzle. With the liquid repellent layer, the inkjet head can suppress the adhesion of the ink to the vicinity of the nozzle. Thus, the inkjet head can suppress the adhesion of the ink to the vicinity of the nozzle without largely reducing the nozzle negative pressure, thereby suppressing the ejection failure. Further, the inkjet head can suppress the ejection failure even without increasing the width of the non-ejection pulse.

### Second Embodiment

Next, the second embodiment is described. The number of the nozzles included in the integrated nozzle of the inkjet printer according to the second embodiment is 2 to 6, which is different from that of the inkjet printer according to the first embodiment. The same symbols are assigned to the other components and the description thereof is omitted.

The nozzle plate 23 is formed by material the Young's modulus of which is higher than or equal to 2 Gpa and is lower than or equal to 100 Gpa. The diameter of each of the first nozzle 36 and the second nozzle 37 is about 35 μm. The diameter of each of the second opening 36B and the fourth opening 37B is about 35 μm.

The inkjet head 10 ejects 10 pL or more every one drop (a liquid drop ejected from the first nozzle 36 and the second nozzle 37 in a single operation). As stated above, the inkjet head 10 includes two nozzles (the first nozzle 36 and the second nozzle 37), thus the inkjet head 10 ejects 20 pL or more in the single ejection operation from each pressure chamber 32.

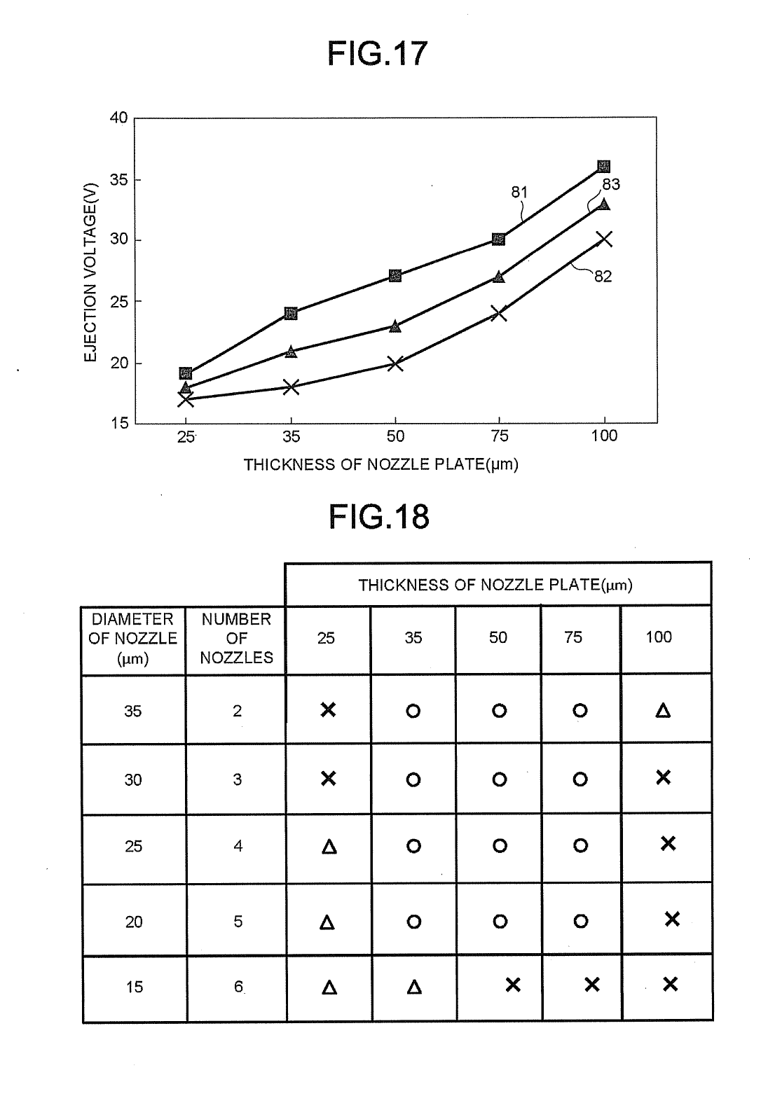

FIG. 17 is a diagram illustrating the relation between the thickness (μm) of the nozzle plate and an ejection voltage (V) applied to the electrode 34 in order to eject the ink. A graph 81 shown in FIG. 17 indicates maximum ejection voltages at which the ink can be ejected. Even applying an ejection voltage higher than the graph 81 to the electrode 34, the inkjet head 10 does not eject the ink from the integrated nozzle 35. As shown in FIG. 17, the maximum ejection voltage at which the ink can be ejected increases as the thickness of the nozzle plate 23 increases.

A graph 82 shown in FIG. 17 indicates minimum ejection voltages at which the ink can be ejected. Even applying an ejection voltage lower than the graph 82 to the electrode 34, the inkjet head 10 does not eject the ink from the integrated nozzle 35. As shown in FIG. 17, the minimum ejection voltage at which the ink can be ejected increases as the thickness of the nozzle plate 23 increases.

A graph 83 shown in FIG. 17 indicates ejection voltages at which a desired amount of the ink is ejected. The inkjet head 10 applies the ejection voltage of the graph 83 to the electrode 34 to eject a desired amount of the ink from the integrated nozzle 35. As shown in FIG. 17, the ejection voltage at which the desired amount of the ink can be ejected increases as the thickness of the nozzle plate 23 increases.

As shown in FIG. 17, in a case in which the thickness of the nozzle plate 23 is 25 μm, the width (an interval between the graph 81 and the graph 82) of the voltage at which the ink can be ejected is about 2V. On the other hand, in a case in which the thickness of the nozzle plate 23 is equal to or higher than 35 μm, the width of the voltage at which the ink can be ejected is wider than that of the voltage in a case in which the thickness of the nozzle plate 23 is 25 μm. Thus, in order to ensure the width of the voltage at which the ink can be ejected, the thickness of the nozzle plate 23 is equal to or higher than 35 μm.

Next, the relation between the thickness of the nozzle plate 23, and the diameter of the nozzle and the number of nozzles is described. FIG. 18 is a diagram illustrating the relation between the thickness of the nozzle plate 23, and the diameter of the nozzle and the number of nozzles. In the example shown in FIG. 18, Young's modulus of the nozzle plate 23 is 3-10 Gpa. In FIG. 18, “o” indicates that the ejection failure does not occur. “x” indicates that the ejection failure occurs. “Δ” indicates that the ejection failure occurs sometimes.

In a case in which the diameter of the nozzle is 35 μm and there are two nozzles, if the thickness of the nozzle plate 23 is 25 μm, the ejection failure occurs. If the thickness of the nozzle plate 23 is 35 μm to 75 μm, the ejection failure does not occur. If the thickness of the nozzle plate 23 is 100 μm, the ejection failure occurs sometimes.

In a case in which the diameter of the nozzle is 30 μm and there are three nozzles, if the thickness of the nozzle plate 23 is 25 μm or 100 μm, the ejection failure occurs. If the thickness of the nozzle plate 23 is 35 μm to 75 μm, the ejection failure does not occur.

In a case in which the diameter of the nozzle is 25 μm and there are four nozzles, if the thickness of the nozzle plate 23 is 25 μm, the ejection failure occurs sometimes. If the thickness of the nozzle plate 23 is 35 μm to 75 μm, the ejection failure does not occur. If the thickness of the nozzle plate 23 is 100 μm, the ejection failure occurs.

In a case in which the diameter of the nozzle is 20 μm and there are five nozzles, if the thickness of the nozzle plate 23 is 25 μm, the ejection failure occurs sometimes. If the thickness of the nozzle plate 23 is 35 μm to 75 μm, the ejection failure does not occur. If the thickness of the nozzle plate 23 is 100 μm, the ejection failure occurs.

In a case in which the diameter of the nozzle is 15 μm and there are six nozzles, the thickness of the nozzle plate 23 is 25 μm or 35 μm, the ejection failure occurs sometimes. If the thickness of the nozzle plate 23 is 50 μm to 100 μm, the ejection failure occurs.

As shown in FIG. 18, if the diameter of the nozzle is 20 μm to 35 μm, and the thickness of the nozzle plate 23 is 35 μm to 75 μm, the ejection failure does not occur. Thus, the inkjet head 10 is equipped with a nozzle plate 23 the thickness of which is 35 μm to 75 μm and on which an integrated nozzle 35 having a plurality of nozzles the diameter of each of which is 20 μm to 35 μm are formed. The control circuit 14 may apply the non-ejection pulse to the channel of the ejection area where the ink is not ejected similar to the first embodiment or may not apply the non-ejection pulse thereto.

The inkjet head with foregoing structure is composed of a nozzle plate the Young's modulus of which is equal to or higher than 2 Gpa and equal to or lower than 100 Gpa. If the Young's modulus of the nozzle plate is lower than 2 Gpa, unevenness of the density of the ink occurs such that the printing quality is reduced. If the Young's modulus of the nozzle plate is higher than 100 Gpa, the following property to the adhesive surface of the driving element is lowered, and the high flatness is necessary. As a result, the increase of the process or the reduction of the yield rate occurs. Thus, the inkjet head according to the embodiment can prevent the unevenness of the density of the ink and prevent the increase of the process or the reduction of the yield rate.

The inkjet head is composed of the nozzle plate the thickness of which is equal to or greater than 35 μm. As a result, the inkjet head can widen the width of the voltage at which the ink can be ejected.

The inkjet head is composed of the nozzle plate 23 the thickness of which is 35 μm to 75 μm and which includes a plurality of nozzles the diameter of each of which is 20 μm to 35 μm. Thus, the inkjet head can reduce the ejection failure.

If the AL is longer, a bubble is difficult to be engulfed in the ink drop. As a result, the ejection failure caused by engulfment of the bubble in the ink drop is reduced. The AL changes depending on the Young's modulus of the nozzle plate 23 and the hole diameter of the nozzle. For example, if the Young's modulus of the nozzle plate 23 becomes small and the hole diameter of the nozzle becomes small, AL becomes long. From this point, it is desired that the Young's modulus is equal to or smaller than 100 Gpa and the hole diameter of the nozzle is equal to or smaller than 40 μm. On the other hand, if the AL is long, the driving period cannot be shortened and the printing at a high speed is difficultly realized. Thus, it is desired that the Young's modulus is equal to or higher than 2 Gpa and the hole diameter of the nozzle is equal to or higher than 20 μm.

The following items are inherent in the embodiment.

(1)

The inkjet head comprises a nozzle plate of which the thickness is 35 μm to 75 μm and the Young's modulus is equal to or higher than 2 Gpa and equal to or lower than 100 Gpa and which includes a first integrated nozzle containing at least two nozzles the diameter of each of which is 20 μm to 35 μm; a first driving element configured to eject ink in a first pressure chamber from the first integrated nozzle; and a control section configured to apply an ejection pulse to the first driving element.

(2)

The inkjet head according to (1) further comprises a second driving element configured to eject ink in a second pressure chamber from a second integrated nozzle; and a common liquid chamber configured to communicate with the first pressure chamber and the second pressure chamber, wherein the nozzle plate further includes the second integrated nozzle containing at least two other nozzles the diameter of each of which is 20 μm to 35 μm; and the control section applies the ejection pulse to the second driving element.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An inkjet head comprising:
a plurality of first driving elements comprising a plurality of first pressure chambers respectively communicating with a plurality of first integrated nozzles;
a plurality of second driving elements comprising a plurality of second pressure chambers respectively communicating with a plurality of second integrated nozzles;
a common liquid chamber configured to communicate with the plurality of the first pressure chambers and the plurality of the second pressure chambers; and
a controller configured to apply an ejection pulse to the plurality of first driving elements and at least one non-ejection pulse to the plurality of second driving elements before an end timing of the ejection pulse.

2. The inkjet head according to claim 1, wherein
the controller respectively divides a plurality of the first pressure chambers and a plurality of the second pressure chambers into a plurality of groups, applies the ejection pulse to one group of the first pressure chambers and applies the non-ejection pulse to one group of the second pressure chambers.

3. The inkjet head according to claim 2, wherein
a plurality of the second driving elements parallel to an arrangement direction of a plurality of the first driving elements is arranged; and
the first integrated nozzle and the second integrated nozzle are arranged alternately with respect to the arrangement direction.

4. The inkjet head according to claim 1, wherein
the non-ejection pulse is a rectangular pulse wave; and
a width of the non-ejection pulse is equal to or higher than one third of time equivalent to half of a natural vibration period in which the nozzle negative pressure of the first pressure chamber or the second pressure chamber changes.

5. The inkjet head according to claim 1, wherein the plurality of first integrated nozzles and the plurality of second integrated nozzles are independently arranged in a longitudinal direction of a nozzle plate.

6. The inkjet head according to claim 1, further comprising:
a plurality of third driving elements comprising a plurality of third pressure chambers respectively communicating with a plurality of third integrated nozzles;
the common liquid chamber configured to communicate with the plurality of the third pressure chambers, the plurality of the first pressure chambers, and the plurality of the second pressure chambers.

7. An inkjet printer comprising:
an inkjet head; and
a supply section configured to supply a print medium on which an image is formed through ink ejected from the inkjet head, wherein
the inkjet head comprises
a plurality of first driving elements comprising a plurality of first pressure chambers respectively communicating with a plurality of first integrated nozzles;
a plurality of second driving elements comprising a plurality of second pressure chambers respectively communicating with a plurality of second integrated nozzles;
a common liquid chamber configured to communicate with a plurality of the first pressure chambers and a plurality of the second pressure chambers; and
a controller configured to apply an ejection pulse to the plurality of first driving elements and at least one non-ejection pulse to the plurality of second driving elements before an end timing of the ejection pulse.

8. The inkjet printer according to claim 7, wherein
the controller respectively divides a plurality of the first pressure chambers and a plurality of the second pressure chambers into a plurality of groups, applies the ejection pulse to one group of the first pressure chambers and applies the non-ejection pulse to one group of the second pressure chambers.

9. The inkjet printer according to claim 8, wherein
a plurality of the second driving elements parallel to an arrangement direction of a plurality of the first driving elements is arranged; and
the first integrated nozzle and the second integrated nozzle are arranged alternately with respect to the arrangement direction.

10. The inkjet printer according to claim 7, wherein
the non-ejection pulse is a rectangular pulse wave; and
a width of the non-ejection pulse is equal to or higher than one third of time equivalent to half of a natural vibration period in which the nozzle negative pressure of the first pressure chamber or the second pressure chamber changes.

11. The inkjet printer according to claim 7, wherein the plurality of first integrated nozzles and the plurality of second integrated nozzles are independently arranged in a longitudinal direction of a nozzle plate.

12. The inkjet printer according to claim 7, further comprising:
a plurality of third driving elements comprising a plurality of third pressure chambers respectively communicating with a plurality of third integrated nozzles;
the common liquid chamber configured to communicate with the plurality of the third pressure chambers, the plurality of the first pressure chambers, and the plurality of the second pressure chambers.

13. An inkjet printing method comprising:
applying an ejection pulse to a plurality of first driving elements comprising a plurality of first pressure chambers respectively communicating with a plurality of first integrated nozzles; and
applying at least one non-ejection pulse to a plurality of second driving elements comprising a plurality of second pressure chambers respectively communicating with a plurality of second integrated nozzles before an end timing of the ejection pulse.

14. The inkjet printing method according to claim 13, wherein the ejection pulse comprises an expansion pulse and a contraction pulse.

15. The inkjet printing method according to claim 13, wherein the ejection pulse comprises a waveform changing at a plurality of stages or a rectangular waveform.

16. The inkjet printing method according to claim 13, wherein the non-ejection pulse comprises a signal having a voltage smaller than a voltage of the signal of the ejection pulse.

17. The inkjet printing method according to claim 13, wherein the non-ejection pulse comprises a signal having a width smaller than a width of a signal of the ejection pulse.

18. The inkjet printing method according to claim 13, wherein the non-ejection pulse comprises a rectangular pulse wave, and the non-ejection pulse wave is shorter than a rectangular pulse wave of the ejection pulse.

19. The inkjet printing method according to claim 13, wherein a timing of the start of the ejection pulse is the same as the start of the non-ejection pulse.

20. The inkjet printing method according to claim 13, further comprising:
applying at least one non-ejection pulse to a plurality of third driving elements comprising a plurality of third pressure chambers respectively communicating with a plurality of third integrated nozzles before an end timing of the ejection pulse.
